(19) United States
(12) Patent Application Publication
(10) Pub. No.: US 2006/0046592 A1
(43) Pub. Date: Mar. 2, 2006

(54) "Thigh sliders", adhesive anti-friction slimming control shields for the upper-inner thighs

(76) Inventor: Denise G. Novelli, Port Jefferson Station, NY (US)

Correspondence Address: Denise G. Novelli, 750 Hallock Avenue Apt. East, Port Jefferson Station, NY, 11776, US

(21) Appl. No.: 11/208,381

(22) Filed: Aug. 20, 2005

Related U.S. Application Data
(60) Provisional application No. 60/603,295, filed on Aug. 21, 2004.

(51) Int. Cl. B32B 33/00; B32B 5/02

(52) U.S. Cl. 442/59; 428/40.1; 428/41.8

(57) ABSTRACT

The present invention, similar in making as to the adhesive bandage, but without the gauze component or related medical association will comprise; modification made to reprocess as a new “method of use” incorporating a high slip agent for desired results. Individuals with slightly overweight inner thighs will now experience both anti-friction and slimming control benefits in one product. Disclosed is an Adhesive Anti-Friction Slimming Control Shield for the Upper-Inner Thighs, that may be produced comprising; Co-polymers and Polyesters, and not limited to; Polyethylene, polypropylene, polyurethane, PVC, polycarbonate, SEBS, TPV, PTFE, Fluoropolymer, Silicone and alike, or a combination blend. This Invention being lightweight, convenient, comfortable, cost effective, stretchable, semi-concealing, water resistant, rectangular in shape, at 3.5″×12″, for easy cutting to size on inner thighs. An alternative to anti-friction creams, gels, liquids, and sprays that provided only anti-friction benefits alone, and will replace restraining fabrics.

### CROSS REFERENCE TO RELATED APPLICATION

This application is related to and claims priority from prior Provisional Patent application, Ser. No. 60/603/295, filed on Aug. 21, 2004.

### BACKGROUND OF THE INVENTION

This invention relates to an adhesive anti-friction slimming control shield for women, the youth and men alike, who are slightly overweight on their upper-inner thighs; in particular this “adhesive” shield being a thin, light weight concealable substrate for the upper-inner thigh area of the body is a break through in comparison to similar products that offer anti-friction and slimming control separately

The combination of being slightly overweight in the inner thigh area, along with the related friction of trapped body heat and moisture causes many problems; In particular, thighs stick together, fabrics riding up and skin becoming irritated with fabrics rubbing up against the skin in this high friction area of the body. Many clothing options are discouraged. Like the bandage aid, people need a thigh aid.

Similar anti-friction or slimming control related products as with; liquids, sprays, gels, cremes, and powders, provide a short-term or minimal solution. They don't provide the combined benefit of an anti-friction, slimming control and lightweight device. Examples of such are heavier fabrics as with the girdle, support wears and leg bands that may contain elasticity properties for slimming, but have proved to be more cumbersome and restraining. Examples of such are; liquids, sprays, gels and cremes that lack the benefit of the slimming control feature that is essential.

A large percentage of people would become encouraged during daily activities, exercising, shopping and socializing, if not for this related discomfort of their thighs. Clothing purchase options would increase, and so would retail sales. Similar products of this invention are not inexpensive and cannot be easily found when you need it. Especially, when heading out the door to go golfing, hiking, jogging, dancing or simply to work and your thighs are slowing you down from getting around. A last minute purchase of this item would be found in your local convenient stores.

### SUMMARY OF THE INVENTION

The object of this present invention provided in a new “method of use” of commercially obtainable plastic films are from a chosen group such as; polyurethane, polyethylene, polypropylene, soft PVC, polycarbonate, SEBS, TPV, Silicone, and polyester, found in various products, primarily the wound care devices.

The inventor of the present invention; being an adhesive anti-friction slimming control shield, and after conducting necessary research of the above polymer films, the preferred polymer extrusion film would be a general purpose “polyester” blend to develop this “shield”, being also the base or primary component of the invention.

In addition to the above polyester in it's finished state of extrusion obtained from source suppliers, the necessary modification will be made to films surface, by applying the necessary “slip agent” or lubricant levels that will provide the required results of an anti-friction slimming control adhesive device.

Another optional modification that may be conducted concerning a “slip agent” would be having the chosen “slip agent” and levels impregnated into the polyester compounds during the preparations when mixing similar polyester formulate prior to extrusion. This modification concerning the added slip agent would directly address the anti-friction properties required within the shield.

Another required and added component would be the PSA, pressure sensitive adhesive acrylic commercially obtainable and applied to one side of the films backing. The last component comprising; a paper release liner to protect the exposed side of the adhesive, which has been applied on the film base itself.

Providing a solution to daily discomfort, inexpensive, lightweight, comfort and increased mobility found in wearing these shields will meet a need for a vast percentage of the population.

### SUMMARY OF INVENTION

This shield will provide those slightly overweight on the upper-inner thighs, a temporary solution until weight is lost. Thighs will slide more easily during activities and related embarrassment found in public with fabrics riding up, in the area of the crotch will be resolved for many.

This invention being a “method of use” discovery obtainable from a commercially made and obtainable polymer film may comprise of; a group of polyurethane, polypropylene, polyester, soft vinyl/PVC, polycarbonate, SEBS, TPV, Silicone and or a combination of these copolymers or co-polyesters.

The preferred substrate for this invention is general-purpose polyester, being either spun-bound or spun-laced, dyed aperture non-woven polyester. Polyester was chosen because of the low co-efficiency of friction. The choice of formulating compounds and extruding film into a solid form is optional, verses having an extruded polyester film sourced, and adding a “slip agents” to surface, so to produce a shield with desired properties that would contain a high surface slip.

Slip agent additives we have considered are chosen from a group comprising; Fluoropolymer, Dimethicone, Lanolin, Tea Tree oil, olive oil, glyceryl polyacrylate, or a silicone type. The preferred slip agent would be similar to that used to coat release liners, being a high molecule weight type, as with a “cross link dry cure system”. A lower molecule weight silicone would migrate to surface, and cause adhesive on shield to come loose.

A PSA adhesive “acrylic” will be applied to one side of shield verses a silicone adhesive that doesn't allow readjustments on skin if necessary. Converter will apply aperture, pinholes throughout shield to increase breath ability of skin pores.

### BRIEF DESCRIPTION OF THE DRAWING

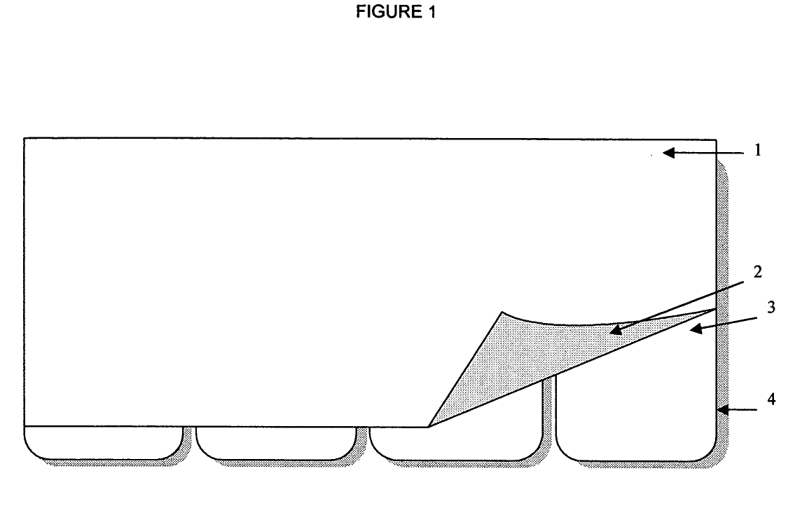

Reference is hereby made to accompanying FIG. 1 Drawing, which illustrates 4 Sections or parts of the present invention, which is also part of the specifications;

SEC #1 there is shown the surface layer of shield #1 made of a single coated polyester substrate comprising incorporation of a “slip agent”, a film surface pigmentation #1, and perforated pin holes #1 for breath ability throughout films layer.

SEC #2 there is shown the same shield #1 comprising; a pressure sensitive acrylic adhesive coating opposite side of #1 which will cover entire layer #2 that will adhere to human skin, and consist of a hypoallergenic, safe for human skin.

SEC #3 there is shown a surface coating of silicone on #3 applied to opposite side of release liner #4 that's also part of present invention, and which side faces backing side of film #2, acting as a protective liner for exposed adhesive on #2.

SEC #4 there is shown a paper release liner backing #4 of the present invention, comprises of also; perforation marks applied to #4 backing, which is opposite silicone coating #3, for purpose of cutting shield to desired sections, when sizing upper inner thighs.

What is claimed in my invention is:

1. An adhesive anti-friction slimming control shield for the upper-inner thighs and a new “method of use” discovery which comprising;
a. A conventional base material; known and used commercially by major manufactures and suppliers in the medical field, similar to adhesive bandage.
b. Materials suitable in producing this invention comprises polymers and not limited to laminates, films, fabrics woven and non-woven, polyolefin; polyvinyl chloride; ethylene vinyl acetate; polyethylene and polypropylene; polyesters, knits and alike.
c. Preferred material for this invention comprises a polyester ethyl soft film, or co-polyester medical grade wound dressings that may be secured as raw material pellets from manufacturer.
d. Same above components secured in pellet form, and during melt process, modification made to incorporate desired levels of a “slip agent” prior to the extrusion of formula produced in a solid form.
e. Extruded film will still contain same dimensional stretch and conformability required for slimming results of said substrate when applied and adhered to upper-inner thigh region of body.
f. Preferred “slip agent” incorporated into preferred polyester compounds during process is a silicone additive, same used in release liners; A “cross link cured dry system” consisting of higher molecule weight Silicone, with no leak through to substrate.

2. Preferred adhesive used to adhere product invention “shield” is a PS “acrylic” adhesive, similar to medical grade applications, applied to substrate backing.

3. Preferred paper release liner, similar to other applications, protects exposed side of substrate film that contains the pressure sensitive adhesive.
